(19) United States
(12) Patent Application Publication
(10) Pub. No.: US 2006/0038867 A1
(43) Pub. Date: Feb. 23, 2006

(54) Inkjet ink with long latency

(76) Inventor: Jose Esteban Valentini, West Chester, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/205,813

(22) Filed: Aug. 17, 2005

Related U.S. Application Data
(60) Provisional application No. 60/602,398, filed on Aug. 18, 2004.

(51) Int. Cl. G01D 11/00

(52) U.S. Cl. 347/100

(57) ABSTRACT

The present invention pertains to inkjet ink with long latency and, more particularly, to an aqueous inkjet ink comprising a specified combination of 1,6-hexandiol and 2-pyrrolidone.

### CROSS-REFERENCE TO RELATED APPLICATIONS

This application claims priority under 35 U.S.C. §119 from U.S. Provisional Application Ser. No. 60/602,398 (filed Aug. 18, 2004), the disclosure of which is incorporated by reference herein for all purposes as if fully set forth.

### BACKGROUND OF THE INVENTION

The present invention pertains to inkjet ink with long latency and, more particularly, to an aqueous inkjet ink comprising a specified combination of 1,6-hexandiol and 2-pyrrolidone.

Inkjet printing is a non-impact printing process in which droplets of ink are deposited on a substrate, such as paper, to form the desired image. The droplets are ejected from a printhead in response to electrical signals generated by a microprocessor. Inkjet printers offer low cost, high quality printing and have become a popular alternative to other types of printers.

A good inkjet ink is characterized by a number of necessary properties, including color, jettability, decap time (latency), drying time and shelf-life, among others. However, there is often a tradeoff between these properties because improving one property can result in the deterioration of another property.

The decap time of the ink is the amount of time a printhead can be left uncapped and idle before the nozzles will clog or plug. A nozzle can become plugged by a viscous plug, by crusting of the ink, or by crystallization of a dye in or around the nozzle. If a nozzle has plugged, ink droplets ejected through the nozzle's orifice may be misdirected, which may adversely affect print quality. If the orifice is completely blocked, ink droplets may not pass at all through the affected nozzle.

Decap is sometimes referred to in the art as “latency” and these two terms will be used interchangeably.

Because not all the nozzles of the printhead print all the time, a printer service routine requires the idle nozzles to “spit” on a regular basis into the waste container (spittoon) to avoid printing defects. It is desirable, however, to service the printhead as infrequently as possible as servicing it is wasteful of ink and slows print speeds. To reduce need for servicing, an ink will preferably have a long decap time.

U.S. Pat. No. 5,766,327 (the disclosure of which is incorporated by reference herein for all purposes as if fully set forth) discloses inks with superior decap time. The inks comprise 5-30 wt % 2-methyl-1,3-pentanediol and 0.1-10 wt % butanediol.

US20030188662 (the disclosure of which is incorporated by reference herein for all purposes as if fully set forth) discloses inks having improved decap time. The most preferred vehicle co-solvents are stated to be selected from 2-pyrrolidone and 1,5-pentanediol.

US2003/0037700 (the disclosure of which is incorporated by reference herein for all purposes as if fully set forth) discloses bleed-alleviating inks comprising a colorant, an aqueous media, a linear diol and a humectant, and optionally a surfactant. While the reference describes the humectant as imparting decap properties, there is no relationship disclosed or even remotely suggested connecting decap properties to combinations of linear diols and surfactants.

There is still a need in the art for inks that possess longer decap time without sacrificing other beneficial properties.

### SUMMARY OF THE INVENTION

The present invention pertains to an aqueous inkjet ink comprising an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink.

In a preferred embodiment, the combination of the two add up to about 20 wt % or less of the total weight of the ink.

In yet another preferred embodiment, the colorant is soluble in the vehicle.

The inks in accordance with the present invention are advantageous in that they provide long decap times as well as other beneficial jetting characteristics.

In accordance with another aspect of the present invention, there is provided an ink set comprising at least three differently colored inks, wherein at least one of the inks is an inkjet ink as set forth above.

In another aspect, the present invention pertains to a printing method comprising the steps of:
(a) providing an ink jet printer that is responsive to digital data signals;
(b) loading the printer with a substrate to be printed;
(c) loading the printer with the above ink and/or ink set, and
(d) printing onto the substrate using the ink and/or ink set in response to the digital data signals.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise. Further, reference to values stated in ranges include each and every value within that range.

### DETAILED DESCRIPTION OF THE PREFERRED EMBODIMENTS

Colorant

Colorants can be soluble in the vehicle (dyes) or dispersed (pigments). In some cases, dye can be encapsulated in a polymer matrix and dispersed like a pigment. The inventive ink is particularly well suited for soluble colorants.

Suitable dyes include anionic, cationic, amphoteric and non-ionic dyes. Such dyes are well known to those of ordinary skill in the art. Typically anionic dyes contain carboxylic or sulfonic acid groups as the ionic moiety. Cationic dyes usually contain quaternary nitrogen groups.

Anionic dyes include Acid, Direct, Food, Mordant and Reactive dyes. Examples include nitroso compounds, nitro compounds, azo compounds, stilbene compounds, triarylmethane compounds, xanthene compounds, quinoline compounds, thiazole compounds, azine compounds, oxazine compounds, thiazine compounds, aminoketone compounds, anthraquinone compounds, indigoid compounds and phthalocyanine compounds.

Cationic dyes include mainly the basic dyes and some of the mordant dyes that are designed to bind acidic sites on a substrate, such as fibers. Examples include the azo compounds, diphenylmethane compounds, triarylmethanes, xanthene compounds, acridine compounds, quinoline compounds, methine or polymethine compounds, thiazole compounds, indamine or indophenyl compounds, azine compounds, oxazine compounds, and thiazine compounds, among others.

Preferred examples of dye colorants are (cyan) Direct Blue 199, Acid Blue 9; (magenta) Acid Red 52, Reactive Red 180, Acid Red 247, Acid Red 37, and Reactive Red 23; (yellow) Direct Yellow 86, Direct Yellow 132 and Acid Yellow 23; and, (black) Direct Black 31, Direct Black 195, Direct Black 168, Food Black 2, Acid Black 194 and Acid Black 172.

Pigments are typically stabilized to dispersion in a vehicle by means of dispersing agents, such as polymeric dispersants or surfactants. Alternatively, pigments can be surface modified to be “self-dispersible” or “self-dispersing” (hereafter “SDP”) which, as the name would imply, are without need for separate dispersant.

Preferably, when a dispersant is employed, the dispersant is a random or structured polymeric dispersant. Preferred random polymers include acrylic polymer and styrene-acrylic polymers. Most preferred are structured dispersants which include AB, BAB and ABC block copolymers, branched polymers and graft polymers. Some useful structured polymers are disclosed in U.S. Pat. No. 5,085,698, EP-A-0556649 and U.S. Pat. No. 5,231,131, the disclosures of which are incorporated by reference herein for all purposes as if fully set forth.

Examples of SDP can be found, for example, in U.S. Pat. No. 5,554,739, U.S. Pat. No. 5,571,311, U.S. Pat. No. 5,609,671, U.S. Pat. No. 5,672,198, U.S. Pat. No. 5,698,016, U.S. Pat. No. 5,707,432, U.S. Pat. No. 5,718,746, U.S. Pat. No. 5,747,562, U.S. Pat. No. 5,749,950, U.S. Pat. No. 5,803,959, U.S. Pat. No. 5,837,045, U.S. Pat. No. 5,846,307, U.S. Pat. No. 5,851,280, U.S. Pat. No. 5,861,447, U.S. Pat. No. 5,885,335, U.S. Pat. No. 5,895,522, U.S. Pat. No. 5,922,118, U.S. Pat. No. 5,928,419, U.S. Pat. No. 5,976,233, U.S. Pat. No. 6,057,384, U.S. Pat. No. 6,099,632, U.S. Pat. No. 6,123,759, U.S. Pat. No. 6,153,001, U.S. Pat. No. 6,221,141, U.S. Pat. No. 6,221,142, U.S. Pat. No. 6,221,143, U.S. Pat. No. 6,277,183, U.S. Pat. No. 6,281,267, U.S. Pat. No. 6,329,446, U.S. Pat. No. 6,332,919, U.S. Pat. No. 6,375,317, U.S. Pat. No. 6,852,156, US2001/0035110, EP-A-1086997, EP-A-1114851, EP-A-1158030, EP-A-1167471, EP-A-1122286, WO01/10963 and WO01/25340, the disclosures of which are incorporated by reference herein for all purposes as if fully set forth.

The pigment particles must be sufficiently small to permit free flow of the ink through the ink jet printing device, especially at the ejecting nozzles that usually have a diameter ranging from about 10 micron to about 50 micron. The particle size also has an influence on the pigment dispersion stability, which is critical throughout the life of the ink. Brownian motion of minute particles will help prevent the particles from flocculation. It is also desirable to use small particles for maximum color strength and gloss. The range of useful particle size is about 0.005 micron to about 15 micron. Preferably, the pigment particle size should range from about 0.005 to about 5 micron, and more preferably from about 0.005 to about 1 micron.

Aqueous Vehicle

An “aqueous vehicle” in the context of the present invention means a mixture of water and at least one water-soluble organic solvent (co-solvent). The 1,6-hexanediol used in the present invention can be considered a water-soluble cosolvent, and the aqueous vehicle in accordance with the present invention comprises water and from about 5% to about 20%, more preferably from about 6% to about 15%, by weight 1,6-hexandiol based on the total weight of the ink.

The aqueous vehicle further comprises from about 4% to about 10%, more preferably from about 5% to about 10%, by weight 2-pyrrolidone, based on the total weight of the ink. The 2-pyrrolidone can also be considered a water-soluble solvent, as it can help in the solubilization of some dyes without materially affecting other critical ink properties. At levels of about 5% by weight and above, the 2-pyrrolidone also may inhibit microbial growth.

Other water-soluble organic solvents commonly employed in inkjet inks, such as those disclosed in U.S. Pat. No. 5,085,698 (the disclosure of which is incorporated by reference herein for all purposes as if fully set forth), may also be included to the extent they do not detrimentally effect the latency properties of the inventive ink. Selection of a suitable mixture depends on requirements of the specific application, such as desired surface tension and viscosity, the selected colorant, drying time of the ink, and the type of substrate onto which the ink will be printed.

The aqueous vehicle typically will contain from about 60% to about 95% water (based on the weight of the aqueous vehicle) with the balance (i.e., from about 40% to about 5%) being the water-soluble cosolvent.

Other Ingredients

Other ingredients may be formulated into an inkjet ink, to the extent that such other ingredients do not interfere with the stability and jetablity of the ink, which may be readily determined by routine experimentation. Such other ingredients are in a general sense well known in the art.

Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec Industries Inc.), organosilicones (e.g. Silwet® series from Witco) and fluoro surfactants (e.g. Zonyl® series from E.I. du Pont de Nemours and Company).

Polymers may be added to the ink to improve durability. The polymers can be soluble in the vehicle or dispersed (e.g. “emulsion polymer” or “latex”), and can be ionic or nonionic. Useful classes of polymers include acrylics, styrene-acrylics and polyurethanes.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Proportions of Ingredients

The components described above can be combined to make an ink in various proportions and combinations in order to achieve desired ink properties, as generally described above, and as generally recognized by those of ordinary skill in the art. Some experimentation may be necessary to optimize inks for a particular end use, but such optimization is generally within the ordinary skill in the art.

For example, the amount of vehicle in an ink is typically in the range of about 70% to about 99.8%, and preferably about 80% to about 99.8%, based on the total weight of the ink.

Colorant will generally be present in amounts up to about 12%, and more typically in the range of about 0.1 to about 9%, by weight based on the total weight of the ink.

Other ingredients (additives), when present, generally comprise less than about 15% by weight, based on the total weight of the ink. Surfactants, when added, are generally in the range of about 0.1 to about 3% by weight based on the total weight of the ink. Polymers can be added as needed, but will generally be less than about 15% by weight based on the total weight of the ink.

Ink Properties

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as about 30 cP at 25° C., but is typically somewhat lower. The ink has physical properties are adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, the application contemplated by this invention will generally require lower viscosity ink. Thus the viscosity (at 25° C.) of the inks can be less than about 3.5 cps. In certain preferred embodiments, the viscosity is less than about 2.5, and even less than about 2.0 cps at 25° C. The surface tension, although not restricted, can, in certain preferred embodiments, be from about 20 to about 35 mN/m and more preferably from about 22 to about 30 mN/m.

Ink Sets

In accordance with another aspect of the present invention, there is provided an ink set comprising an inkjet ink as described above. This ink set more preferably comprises at least three differently colored inks (such as CMY), and more preferably at least four differently colored inks (such as CMYK), wherein at least one of the inks is an ink as described above.

The other inks of the ink set are preferably aqueous inks, and may contain dyes, pigments or combinations thereof as the colorant. Such other aqueous inks are based on aqueous vehicles and other components and additives as described above or as otherwise are known to those of ordinary skill in the art and may, in a general sense, be considered known to those of ordinary skill in the art.

The ink sets more preferably comprise at least three primary inks: at least one cyan ink, at least one magenta ink and at least one yellow ink. Each of these primary inks is in turn comprised of a vehicle and an appropriate colorant dispersed (pigment) and/or dissolved (dye) in the vehicle, with at least one (and preferably all) of the inks being an ink as described above.

The ink set may optionally include a black ink, preferably comprising carbon black pigment. When present, the carbon black pigment is preferably an SDP as described above.

The black colorant may also be dye as, for example, the black dye disclosed in U.S. Pat. No. 5,753,016. The black colorant may also be a combination of dye and pigment as, for example, disclosed in U.S. Pat. No. 6,277,184. The disclosures of both of the preceding references are incorporated by reference herein for all purposes as if fully set forth.

Methods of Printing

The inks and ink sets of the present invention can be utilized by printing with any inkjet printer. The substrate can be any suitable substrate, including plain and treated papers, and textiles.

### EXAMPLES

Latency Test

Latency (Decap time) was determined according to the following procedure using a Hewlett Packard 850 printer that was altered so that the ink cartridge would not be serviced during the test. Just prior to the beginning of the test, the nozzles were primed and a nozzle check pattern was performed to ensure all nozzles were firing acceptably. No further servicing was then conducted During each scan across the page, the pen printed a pattern of 149 vertical lines spaced about 1/16 inch apart. Each vertical line was formed by all nozzles firing one drop, therefore the line was one drop wide and about ½ inch high corresponding to the length of the nozzle array on the printhead. The first vertical line in each scan was the first drop fired from each nozzle after the prescribed latency period, the fifth line was the fifth drop from each nozzle on that scan, and so forth for all 149 lines.

The pattern was repeated at increasingly longer time intervals (decap times) between scans. The standard time intervals between scans was 1, 2, 3, 4, 5, 6, 7, 8, 9, 10, 20, 30, 40, 50, 60, 70, 80, 90 100, 200, 300, 400, 500, 600, 700, 800, 900 and 1000 seconds. Nothing beyond 1000 seconds was attempted.

Upon completion of the test, the 1st, 5th and 32nd vertical lines in each scan was examined for consistency, misdirected drop deposits, and clarity of the print. These lines correspond to the 1st, 5th and 32nd drops of ink droplets ejected from the nozzle after a prescribed latency period. The decap time was the longest time interval where the particular vertical line could be printed without significant defects.

Ideally, the pen should fire properly on the first drop; however, when the first drop failed to eject properly, the decap time for the 5th and 32nd drops indicated the severity of the pluggage and how easily the nozzles could be recovered.

Preparation of Inks

Inks were prepared according to the following formulations. Proportions are in percent weight of the total weight of ink. Ingredients were mixed together and filtered. Water was deionized. The pH was adjusted as needed with aqueous KOH to achieve the reported pH value. Byk® 348 is a surfactant from Byk Chemie. Aerosol® OT is a surfactant from Cytec Industries Inc. Viscosity was measured with a Brookfield viscometer at 25° C. Surface tension was measured with a Kruss K-12 tensiometer (Wilhelmy plate method), also at 25° C.

### Example 1 (Comparative)

Inks A and B, were two comparative commercial inks extracted from an HP15 (Ink A) and an HP78 (Ink B) cartridge (Hewlett Packard). Ink A was black-pigmented ink, and Ink B was cyan dye-based ink. Both Ink A and Ink B had a decap time of less than 100 seconds, with a 1^{st} drop decap time of less than 60 seconds.

| Materials | Ink A | Ink B |
|---|---|---|
| Commercial Black (HP15) | 100 | |
| Commercial Cyan (HP78) | | 100 |
| pH | 7.9 | 5.9 |
| Viscosity (cps) | 2.7 | 3.1 |
| Surface Tension (mN/m) | 47.6 | 30.2 |
| Decap Time | | |
| 1st line | 30 | 50 |
| 5th line | 100 | 80 |
| 32nd line | 100 | 100 |

### Example 2

Inks 1-3 below were tested and all are shown to have very good decap performance. Also, all printed well and provided good images.

| Ingredients | Ink 1 | Ink 2 | Ink 3 |
|---|---|---|---|
| Acid Red 249 | 2.6 | 2.6 | 2.6 |
| 2-pyrrolidone | 5.0 | 5.0 | 5.0 |
| 1,6-hexanediol | 9.0 | 9.0 | 9.0 |
| Aerosol ® OT | 0.25 | 0.25 | — |
| Byk ® 348 | 0.2 | — | 0.2 |
| Water | Balance | Balance | Balance |
| | to 100 | to 100 | to 100 |
| pH | 8.2 | 8.2 | 8.0 |
| Viscosity (cps) | 1.8 | 1.7 | 1.7 |
| Surface Tension (mN/m) | 23.7 | 30.0 | 22.6 |
| Decap Time | | | |
| 1st line | >1000 | >1000 | >1000 |
| 5th line | >1000 | >1000 | >1000 |
| 32nd line | >1000 | >1000 | >1000 |

### Example 3

Additional inks were prepared according to the following recipes. All inks printed well and showed long decap times.

| Ingredients | Ink 4 | Ink 5 |
|---|---|---|
| Direct Blue 199 | 1.9 | — |
| Acid Yellow 132 | — | 3.0 |
| 2-pyrrolidone | 5.0 | 5.0 |
| 1,6-hexanediol | 9.0 | 9.0 |
| Aerosol ® OT | 0.25 | 0.25 |
| Byk ® 348 | 0.2 | 0.2 |
| Water | Balance | Balance |
| | to 100 | to 100 |
| pH | 7.91 | 8.09 |
| Viscosity (cps) | 2.0 | 2.15 |

1. An aqueous inkjet ink comprising an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink.

2. The aqueous inkjet ink of claim 1, wherein the aqueous vehicle comprises water and from about 6% to about 15% by weight 1,6-hexanediol, and from about 5% to about 10% by weight 2-pyrrolidone, based on the total weight of ink.

3. The aqueous inkjet ink of claim 1, wherein the combination of 1,6-hexanediol and 2-pryyolidone is about 20% by weight or less, based on the total weight of the ink.

4. The aqueous inkjet ink of claim 2, wherein the combination of 1,6-hexanediol and 2-pryyolidone is about 20% by weight or less, based on the total weight of the ink.

5. The aqueous inkjet ink of claim 1, having a viscosity of less than about 2.5 cps at 25° C.

6. The aqueous inkjet ink of claim 1, wherein the colorant is soluble in the aqueous vehicle.

7. The aqueous inkjet ink of claim 5, wherein the colorant is selected from the group consisting of Direct Blue 199, Acid Red 249 and Direct Yellow 132.

8. An inkjet ink set comprising at least three differently colored inks, wherein at least one of the inks is an aqueous inkjet ink comprising an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink.

9. The inkjet ink set of claim 8, comprising:
a cyan ink comprising an aqueous vehicle and a cyan colorant dispersed and/or dissolved in the aqueous vehicle;
a magenta ink comprising an aqueous vehicle and a magenta colorant dispersed and/or dissolved in the aqueous vehicle; and
a yellow ink comprising an aqueous vehicle and a yellow colorant dispersed and/or dissolved in the aqueous vehicle;
wherein at least one of the inks is an aqueous inkjet ink comprising an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink.

10. The inkjet ink set of claim 9, wherein each of the cyan ink, the magenta ink and the yellow ink independently comprises an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink.

11. The inkjet ink set of claim 9, further comprising an aqueous black inkjet ink.

12. A printing method comprising the steps of:
(a) providing an ink jet printer that is responsive to digital data signals;
(b) loading the printer with a substrate to be printed;
(c) loading the printer with the an ink, and
(d) printing onto the substrate using the ink in response to the digital data signals,
wherein the ink is an aqueous inkjet ink comprising an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink.

13. The printing method of claim 12, wherein the printer is loaded with an inkjet ink set comprising at least three differently colored inks, wherein at least one of the inks is an aqueous inkjet ink comprising an aqueous vehicle and a colorant dissolved and/or dispersed in the aqueous vehicle, wherein the aqueous vehicle comprises water and from about 5% to about 20% by weight 1,6-hexanediol, and from about 4% to about 10% by weight 2-pyrrolidone, based on the total weight of ink; and wherein the substrate is printed onto using the inkjet ink set.
